(19) United States
(12) Patent Application Publication
(10) Pub. No.: US 2005/0203843 A1
(43) Pub. Date: Sep. 15, 2005

(54) Internet debit system

(76) Inventors: George Luis Wood, Alamo, CA (US); Michelle Banaugh, Novato, CA (US)

Correspondence Address: GLENN PATENT GROUP, 3475 EDISON WAY, SUITE L, MENLO PARK, CA, 94025, US

(21) Appl. No.: 10/800,202

(22) Filed: Mar. 12, 2004

(51) Int. Cl. G06F 17/60

(52) U.S. Cl. 705/40

(57) ABSTRACT

A PIN based Internet debit system and method is provided. The system and method allow for the transmission of an eCommerce Internet transaction with a debit card or ATM card and the cardholders existing PIN. In addition, the system and method allow for secure and encrypted transmission of such PIN and transaction data via the Internet to the payment network and the issuing financial institution. In one embodiment of the invention, a pop-up is used to get control of a user's browser to present a PIN pad such that the user may enter PIN information associated with the user's debit/ATM cards. In this way, the invention provides debit card or ATM type functionality to web pages.

### BACKGROUND OF THE INVENTION

1. Technical Field

The invention relates generally to an Internet debit system. More particularly, the invention relates to a system and method for PIN purchasing technology and processes for transmitting a PIN based debit transaction via the Internet for eCommerce transactions.

2. Description of the Prior Art

ATM machines are found throughout the world in a variety of settings and have become an assumed component of the lifestyle of millions. They operate at hours and in locations not serviced by regular financial institutions, providing a significant set of services to anyone possessing an access card and password sequence, which is often a four keystroke sequence known as a Personal Identification Number (PIN). Access to the user's finances can be attained. Cash can be received and/or transferred, which is accordingly credited or debited against the financial account. The account status may be viewed, as can a log of recent transactions.

A debit card is assigned and given to a user in order to access his account via an ATM machine. Typically, the debit card is a plastic card like a credit card and has a magnetic strip storing pertinent user account informational and other essential informational data. The user inserts the card into a slot on the ATM, enters his PIN, and is guided through various options that are mostly financial-based.

In addition, the user can make point of sale purchases at certain merchant stores, such as a grocery store, by swiping his debit card through a device that reads the data on the magnetic strip. Then by entering the PIN, the user authorizes the purchase and the amount is debited from his bank account.

Another venue for point of sale transactions is the Internet for eCommerce. Using the debit card and PIN for Internet transactions poses unique problems. Currently, a problem exists in transmitting a debit cardholder's PIN via the Internet and the ability for consumer and online merchants to use PIN based debit transactions at the Internet point of sale.

Some techniques for trying to solve the problem include issuing smart card readers to consumers, or issuing CD/ROM based debit cards to consumers. Other methods for attempting to create a secure, alternative payment type for the Internet include enabling alternative payment types, such as electronic checks and stored value cards. Additionally on the Internet, credit card authentication technology is used for authenticated credit card and check card transactions.

However, in each of these technologies, there is an excessive burden for the consumer and for the merchant. For example, an undo burden is put on the consumer or the credit card issuer when a piece of hardware has to be installed on a consumer's personal computer or the consumer is issued a new CD/ROM card.

Solutions employing such techniques are equally implausible. In the case of alternative payments, such as stored value cards, consumers want to use the accounts that they are able to use in the physical world in the Internet world. That is, as an alternative to stored value cards/accounts that are typically tied to one merchant/limited services, consumers can use their existing accounts in both the physical world (POS, ATMs, etc.) as well as the Internet. In the case of credit card authentication technology, consumers must register and thus remember a new password. Additionally, the checkout process is interrupted because the transaction has to be handed off for authentication and validation to several service providers, i.e. from merchant to associations to acquirers to issuers back to the acquirer to the merchant and finally to the customer. Additionally, the merchants have significant integration work just to process the transaction correctly, let alone to provide a semi-seamless process for consumers.

Michael Daly and Thomas A, Grate, Computerized purchasing system and method for mediating purchase transactions over an interactive network, U.S. Pat. No. 5,878,141 (Mar. 2, 1999) discloses a computerized, electronic purchase mediating system which includes a purchaser database having a list of purchasers and a merchant database having a list of merchants. The purchaser database stores information about each purchaser including a set of personal payment methods that the purchaser could use to purchase goods and/or services. Similarly, the merchant database stores information about each merchant including a set of accepted payment methods that the merchant accepts for sale of the goods and/or services. The purchase system also includes a processor coupled to the purchaser and merchant databases. The processor receives a purchase request and accesses the merchant database according to a merchant identified in the purchase request to retrieve the set of accepted payment methods which corresponds to that merchant. The processor also accesses the purchaser database to retrieve the set of personal payment methods that corresponds to the identified purchaser. The processor then computes an intersection of these two sets to derive a common set of any available payment method that is both accepted by the merchant and can be used by the purchaser for purchase of the goods and/or services. The purchaser is presented with the purchase amount and the common set of available payment methods to choose a most preferred form of payment. Upon selection, the processor consummates the sale and signs a digital signature with the purchaser's permission via password verification to ensure for the merchant that a completed transaction has occurred.

Balas Natarajan Kausik, Method and apparatus for cryptographically camouflaged cryptographic key storage, certification and use, U.S. Pat. No. 6,170,058 (Jan. 2, 2001) discloses a digital wallet that stores a cryptographically camouflaged access-controlled datum, e.g. a private key encrypted under the user's PIN. Entry of the correct PIN correctly decrypts the stored key. Entry of certain pseudo-valid PINs will also decrypt the stored key, but improperly so, resulting in a candidate key indistinguishable from the correct key. Such pseudo-valid PINs are spread thinly over the space of PINs, so that the user is unlikely to realize a pseudo-valid PIN via a typographical error in entering the correct PIN. In existing wallet technologies, which lack pseudo-valid PINs, only the correct PIN produces a decrypted key; thus, hackers can find the correct PIN by entering all possible PINs until a key is produced. The disclosure teaches plurality of candidate keys prevents a hacker from knowing when he has found the correct key. In addition, hacker detection may be moved off-line into devices accepting messages signed with candidate keys, and/or the lockout threshold may be increased. Thus, the wallet can be forgiving of typographic or transposition errors, yet a hacker trying a large numbers of PINs will eventually guess a pseudo-valid (but still incorrect) PIN and recover a candidate private key whose fraudulent use will be detected. The wallet may be used with associated key generation, certification, and verification technologies. Such technologies may include pseudo-public keys embedded in pseudo-public certificates, i.e. public keys that are not generally known and which are contained in certificates that are verifiable only by entities so authorized by the certifying authority.

Douglas Hoover, Method and apparatus for secure entry of access codes in a computer environment, U.S. Pat. No. 6,209,102 (Mar. 27, 2001) discloses that a user inputting his access code, e.g. PIN or password, into a computing environment to access a transaction is at risk of losing the access code to an attacker who has physical or electronic access to the computing environment. To minimize this risk, the access code can be entered via a plurality of user-selectable fields, each of which takes on a series of values, the initially displayed values of which are established in a random or otherwise unpredictable manner. The user then uses a mouse, keyboard, or other input device to increment each of the selectable fields until the access code is correctly entered. Because of the randomization of the initial state, an attacker tracking the locations or number of mouse clicks or other navigation actions can not determine the finally entered access code by techniques, e.g. computing an offset from a known initial state.

Len L. Mizrah, System and method for private and secure financial transactions, EP1223524 (Jul. 17, 2002) discloses a system and method for private and secure financial transactions. The technique comprises embedded into financial institutions privacy and security layer architecture and clocked authentication, authorization and accounting (AAA) method. The technique enables legal financial account holders to perform buy/sell or withdraw/deposit financial transactions without disclosing private personal information to the transaction counterparts, while preserving security and fraud protection. Before the financial transaction, the financial account holder initiates an authentication session with the financial institution back office by accessing its central processing unit and data base, configured in the embedded privacy and security layer architecture (EPSL) with automated clocked AAA sessions by using dedicated communication lines. The authentication session is interactive, transaction specific, and followed by either financial transaction deny or an alphanumeric signature generated for this specific financial transaction. Then financial account holder submits his/her request to a transaction counterpart along with the EPSL account number and the alphanumeric signature, generated by the financial institution EPSL during a previous authentication session. The transaction counterpart adds up additional or more refined financial transaction specific information and requests an authorization session with the financial institution back office where the EPSL account, CPU and database are residing. The accounting session starts at the end of the authentication session and finishes along with the authorization session while being an essential part of them both.

It is readily apparent that there is a need to provide a PIN based Internet debit system that allows for the transmission of an eCommerce Internet transaction with a debit card or ATM card and with the cardholder's existing PIN. It would be further advantageous to provide a system and method that provides a secure and encrypted transmission of such PIN and of transaction data via the Internet to the payment network and to the issuing financial institution. It would be further advantageous to provide a secure system and method that:

does not require any additional hardware on the part of the consumer;

does not require the consumer to register and remember a new password;

does not interrupt the existing checkout processes at the merchant web site;

protects consumers and merchants from fraud via real time authentication of the PIN;

provides a guarantee of good funds to the merchant, which is an improvement over using an ACH card or an eCheck;

uses the existing bank, ATM network, and point of sale infrastructure to process Internet transactions as well as manage chargebacks; and

does not require that the issuing bank reissue new cards.

### SUMMARY OF THE INVENTION

A PIN based Internet debit system and method is provided. The system and method allow for the transmission of an eCommerce Internet transaction with a debit card or ATM card and the cardholders existing PIN. In addition, the system and method allow for secure and encrypted transmission of such PIN and transaction data via the Internet to the payment network and the issuing financial institution. In one embodiment of the invention, a pop-up is used to get control of a user's browser to present a PIN pad such that the user may enter PIN information associated with the user's debit/ATM cards. In this way, the invention provides debit card or ATM type functionality to web pages.

### BRIEF DESCRIPTION OF THE DRAWINGS

FIG. 1 is a PIN purchase authorization system diagram that also shows system flow according to the invention;

FIG. 2 is a process diagram according to the invention; and

FIG. 3 is a process diagram of PIN pad processing according to the invention.

### DETAILED DESCRIPTION OF THE INVENTION

A PIN based Internet debit system and method is provided. The system and method allow for the transmission of an eCommerce Internet transaction with a debit card or ATM card and the cardholders existing PIN. In addition, the system and method allow for secure and encrypted transmission of such PIN and transaction data via the Internet to the payment network and the issuing financial institution. In one embodiment of the invention, a pop-up is used to get control of a user's browser to present a PIN pad such that the user may enter PIN information associated with the user's debit/ATM cards. In this way, the invention provides debit card or ATM type functionality to web pages.

Overview

The invention allows debit cardholders and ATM cardholders to conduct transactions over the Internet by paying for the purchases using their existing PINs as an authentication method in that purchase. Merchants work with the third party providers of the floating PIN pads. The invention provides Application Programming Interface messages (APIs) to merchants to program their web page to enable a PIN based debit payment type on their web site as part of the merchant's check out process. The APIs provide the universal, standard language and message structure that is used to communicate with the merchant and adopted by all third party providers. When the consumer selects this payment type, the consumer is redirected to a new URL, which pops up an authentication module referred to herein as the floating PIN pad. It should be appreciated that that floating PIN pad has a number arrangement of its PIN keys, the arrangement of which change every time a number is entered. Such PIN pad itself floats around on the screen. Such method prevents hacking wherein the PIN is identified by the pointing of and the location of every item on the particular page. Therefore, a hacker cannot determine what the consumer is doing with his mouse clicks or the equivalent input device. In addition, with the floating PIN pad, a consumer is not able to enter the PIN using a keyboard, thereby preventing hackers from determining the PIN from any keyboard activity. It should be appreciated that right after the consumer enters his PIN, the embedded PIN pad module encrypts the PIN. Such immediate encryption is accomplished without any additional requirements for the consumer, such as downloading any applets or registering for any new process. The associated transaction is then delivered through the system and submitted to the acquiring financial institution, where the acquiring financial institution (acquirer) is the service provider that processes the transactions for/on behalf of a merchant. At such point in time, the transaction is passed along to a card network, such as Star or Interlink, for example. Alternatively, if the transaction is internal to the acquiring financial institution (on us), the transaction is passed to the appropriate internal processing module. For example, the transaction may be passed to an ATM group, where such PIN and transaction information is decrypted and the transaction continues through normal processing channels. That is, for example the PIN and transaction information follows the same processing convention that a typical point of sale or ATM transaction uses, which leverage existing retail deposit systems and available balances. A message is delivered back to the merchant's web site stating whether or not the transaction is approved. Finally, if approved, the appropriate funds are debited from the consumer's Data Deposit Account (DDA), for example a checking account, instantaneously.

It should be appreciated that the PIN is never passed in the clear over the Internet. That is, there is no point in time when the PIN is sitting out on the Internet in the clear in any way, shape or form. A particular PIN number is encrypted as it is entered in the floating PIN pad. The encrypted PIN is then decrypted using the same methodology used for decrypting ATM transactions coming from a point of sale. There are currently very stringent security requirements for processing PINs that are typically hardware based.

It should be appreciated that the invention provides an integrated solution including merchant protocol, acquiring bank protocol, network protocol, and DDA protocol. The protocol is a DNA imprint that uniquely qualifies all participants within the eCommerce transaction and maintains their integrity.

Benefits to the Merchant

A merchant has the ability to have guaranteed funds from an authenticated user. The merchant is protected from a number of the charge backs that they're exposed to today, because the issuing bank assumes the liability in the instance of a submission with the PIN. In addition, it is likely that the financial institution will charge less for PIN purchasing payment option than for other debit transactions or credit card transactions. Therefore, for the merchant it's a lower-cost, lower-risk, more secure solution that doesn't require a lot of integration, and doesn't push the merchant's customer to have to engage in an extra registration process, downloading software, or purchasing a card reader.

Benefits to the Consumer

From a consumer's perspective, some research has demonstrated that consumers feel much more comfortable, or would feel much more comfortable, if they could use their PIN with their card on the Internet. Additionally, there is a population of consumers who don't have a check card, in other words a debit card with a credit card logo on it, but have only a straight ATM card. With the invention, the consumer can use it to purchase items on the Internet. Also, the merchant's systems and clerks never see or need to use the customer's PIN. It should be appreciated that a customer's card number and PIN number are processed separately. This is a security precaution that ensures both pieces of information, which significantly reduces potential fraud.

System Architecture

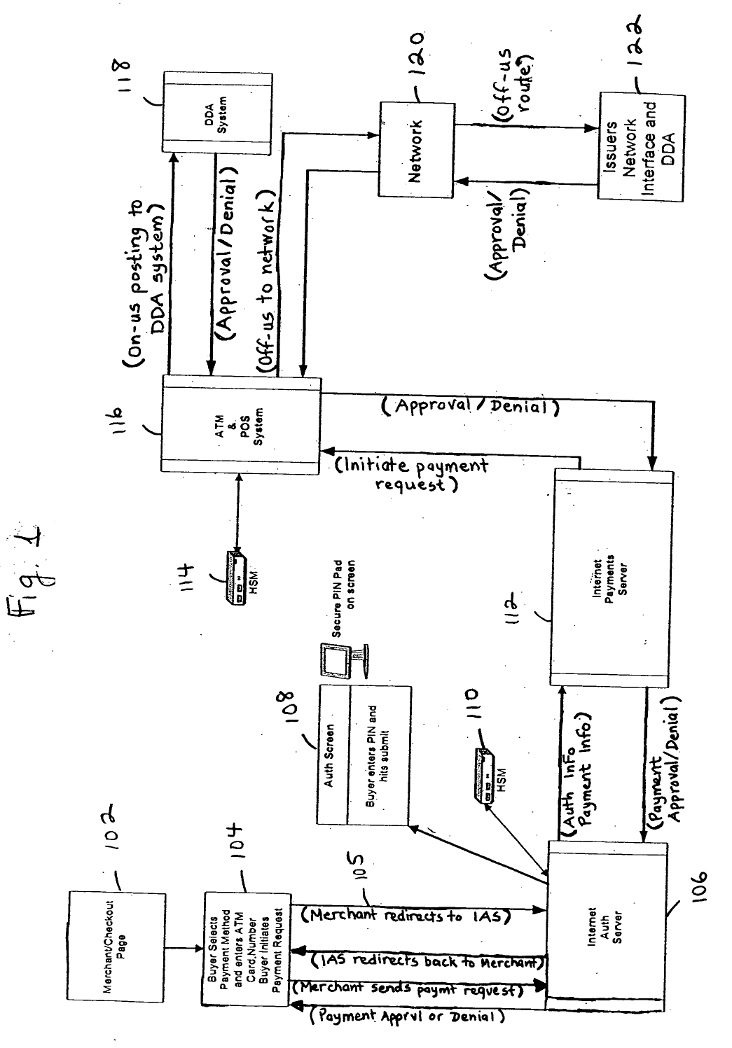

One embodiment of the invention is described with respect to FIG. 1, a PIN purchase authorization system diagram that also shows system flow according to the invention. A buyer fills his shopping cart and proceeds to the merchant's checkout page 102. From the same or a different check out page, the buyer selects PIN Purchase as his payment method and enters or selects his debit card number 104. The merchant system re-directs the buyer's browser 105 to an Internet Authorization Server (IAS) 106, passing along a unique transaction id. The IAS 106 displays a secure PIN pad screen 108 and uses a unique session key under Secure Sockets Layer (SSL) technology, described in further detail herein below. The buyer enters his PIN using a mouse or similar input device. The PIN is encrypted using the unique session key passed to the IAS. The IAS passes the encrypted PIN to a Host Security Module (HSM) 110, which is also capable of encrypting and decrypting PINs, to generate an encrypted ANSI PIN Block. The ANSI PIN block is passed back to the IAS 106. The IAS 106 returns control of the buyer's browser to the merchant and passes along the unique transaction id, which is used as a key for encryption purposes. The merchant server (102, 104) creates a payment request based on the contents of the shopping cart and the payment method. The merchant then sends the payment request through the IAS 106 over a secure link to an Internet Payments Server 112. The Internet Payments Server 112 determines the payment type and formats a payment authorization request. The payment authorization request is routed to an ATM/POS system 116. The ATM/POS system 116 takes the encrypted ANSI PIN block passed along with the payment request and routes it through a different HSM 114 to be decrypted and translated to the acquiring financial institution, the ATM/POS system 116 encrypted PIN data. If the transaction is an on-us transaction, then the ATM/POS system 116 validates the PIN and passes the transaction amount to an associated DDA system 118 for authorization. If the transaction is an off-us transaction, then the authorization request is routed to a network 120 to be further routed to the buyer's issuing financial institution 122. The authorization approval or denial is passed back to the ATM/POS system 116, routed to the Internet Payments Server 112, through the IAS 106, and finally back to the merchant server (102, 104).

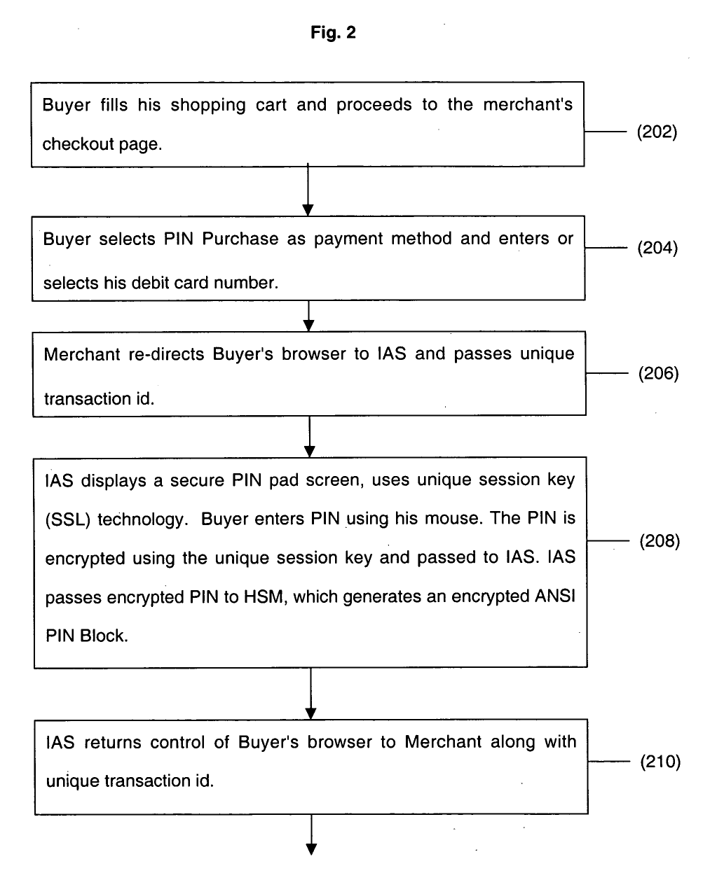

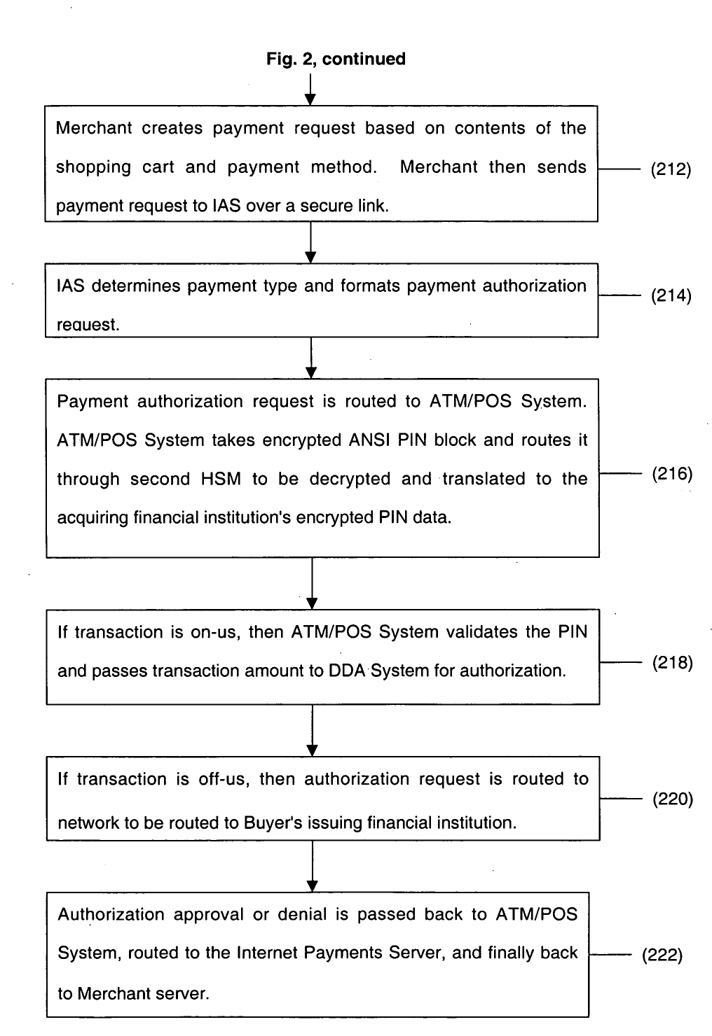

One embodiment of a process according to the invention is described with reference to FIG. 2, a process diagram according to the invention, as follows:

A buyer fills his shopping cart and proceeds to the merchant's checkout page. (202)

The buyer selects PIN Purchase as his payment method and enters or selects his debit card number. (204)

The merchant re-directs the buyer's browser to an Internet Authorization Server (IAS) and passes a unique transaction id. (206)

The IAS displays a secure PIN pad screen and uses a unique session key under Secure Sockets Layer (SSL) technology. The buyer enters his PIN using his mouse or other input device. The PIN is encrypted using the unique session key and passed to the IAS. The IAS passes the encrypted PIN to an HSM, which then generates an encrypted ANSI PIN Block. (208)

Upon receiving the ANSI PIN block, the IAS returns control of the buyer's browser to the merchant along with the unique transaction id. (210)

The merchant creates a payment request based on the contents of the shopping cart and the payment method. The merchant then proceeds to send the payment request to the Internet Payments Server over a secure link. (212)

The Internet Payments Server determines the payment type and formats a payment authorization request. (214)

The payment authorization request is routed to an ATM/POS System. The ATM/POS System takes the encrypted ANSI PIN block and routes it through a second HSM to be decrypted and translated, i.e. is put into a secure format that the target acquiring financial institution uses for processing their proprietary encrypted PIN data. (216)

If this transaction is an on-us transaction, then the ATM/POS System validates the PIN and pass the transaction amount to a DDA System for authorization. (218)

If this transaction is an off-us transaction, then the authorization request is routed to the network to be routed to the buyer's issuing financial institution. (220)

The authorization approval or denial is passed back to the ATM/POS System, routed to the Internet Payments Server and finally back to the merchant server. (222)

An Exemplary PIN Pad

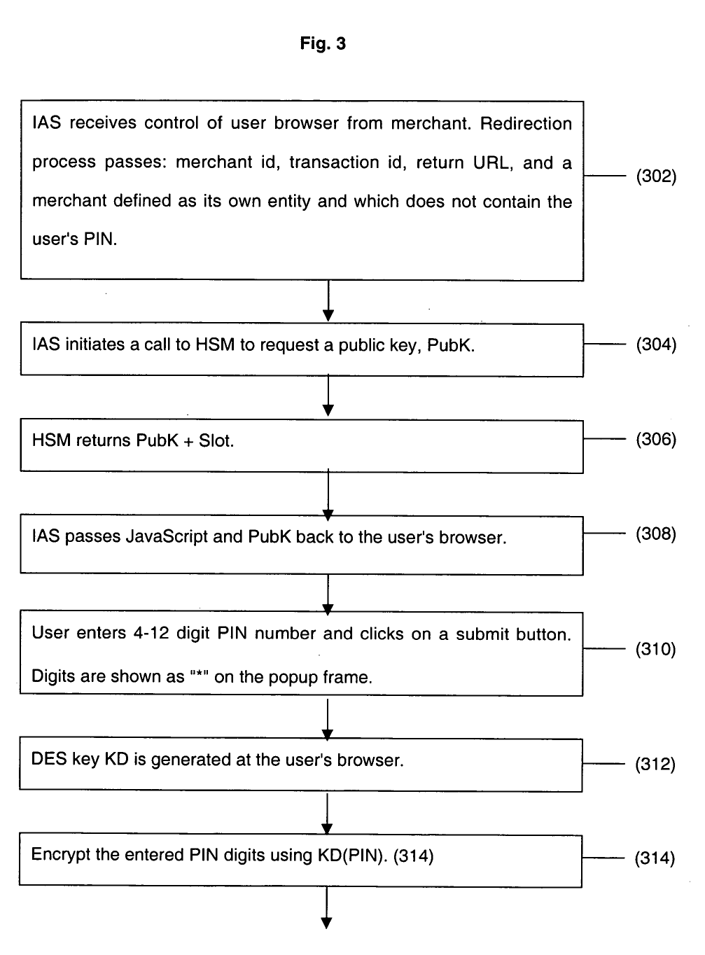

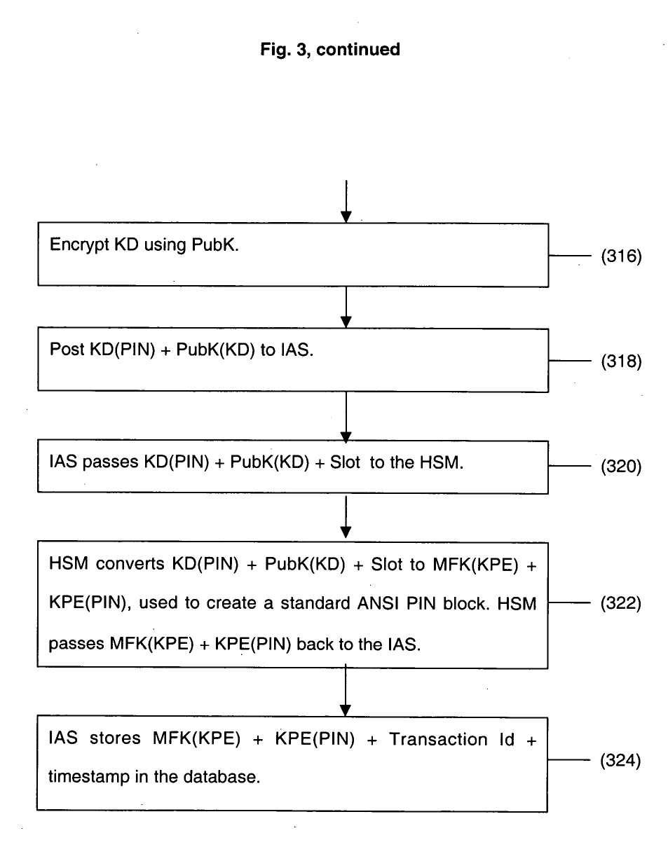

Following is an example algorithm performed by some of the main modules of the invention to ensure the encryption of the user's PIN. Refer to FIG. 3, a process diagram of PIN pad processing according to the invention.

The IAS receives control of the user browser from the merchant. The redirection process passes the following informational data: merchant id, transaction id, return URL, and a merchant defined as its own entity and which does not contain the user's PIN. (302)

The IAS initiates a call to the HSM to request a public key, PubK. (304)

The HSM returns PubK+Slot. (306)

The IAS passes JavaScript, which handles the navigation/redirection/pertinent information between browsers, and PubK back to the user's browser. (308)

The user enters his PIN, for example a enters 4-12 digit number and clicks on a submit button. Digits are hidden, for example shown as “*” on the popup frame. (310)

A Data Encryption Standard (DES) key KD is generated at the user's browser. (312)

Encrypt PIN digits entered on the browser using KD(PIN). For example, encrypt using single length DES encryption or stronger if preferred and supported. (314)

Encrypt KD using PubK and an algorithm that is dynamically accessed at the time of encryption. (316).

A process that is integrated with the IAS posts KD(PIN)+PubK(KD) to the IAS. (318).

The IAS passes KD(PIN)+PubK(KD)+Slot to the HSM. (320)

The HSM converts KD(PIN)+PubK(KD)+Slot to MFK(KPE)+KPE(PIN). Such conversion takes the multiple information components and creates a standardized format for subsequent processes. For example, the conversion is used to create a standard ANSI PIN block. The HSM passes MFK(KPE)+KPE(PIN) back to the IAS. (322)

IAS stores MFK(KPE)+KPE(PIN)+Transaction Id+timestamp in the database specifically designed to house Internet debit transactions. (324)

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A system for making a purchase transaction by PIN purchasing over the Internet comprising:
a merchant's check out web page on a merchant server for a buyer to make a purchase from the buyer's browser;
means for the buyer selecting PIN purchase as a payment method and for entering a debit card number;
an Internet authorization server to which the merchant system re-directs said buyer's browser and to which the merchant system passes along a unique transaction id coupled to said transaction;
means for said Internet authorization server displaying a secure PIN pad screen and using a unique session key;
an input device for the buyer to enters a PIN;
means for encrypting said using said unique session key;
a host security module to which said Internet authorization server passes said encrypted PIN, said host security module generating an encrypted ANSI PIN block;
means for said ANSI PIN block passing back to said Internet authorization server;
means for said Internet authorization server returning control of said buyer's browser to said merchant server and passing along said unique transaction id;
a payment request based on contents of a shopping cart and said payment method, wherein said payment request is created by said merchant server;
an Internet payments server to which said merchant server sends said payment request, wherein said Internet payments server determines said payment type and formats a payment authorization request;
an ATM/POS system to which said payment authorization request is routed, wherein said ATM/POS system takes said encrypted ANSI PIN block passed along with said payment request and routes said ANSI PIN block through a second host secure module to be decrypted and translated;
a data deposit account system wherein if said transaction is an on-us transaction, then said ATM/POS system validates said PIN and passes a transaction amount coupled to said transaction to said associated data deposit account system for authorization;
a network coupled to the buyer's issuing financial institution, wherein if said transaction is an off-us transaction, then said authorization request is routed to said network to be further routed to said buyer's issuing financial institution;
means for passing back to said ATM/POS system and finally back to said merchant server an authorization approval or denial.

2. The system of claim 1, wherein said unique session is under Secure Sockets Layer (SSL) technology.

3. The system of claim 1, wherein a link between said Internet authorization server and said Internet payments server is a secure link.

4. The system of claim 1, wherein said means for encrypting a user's PIN further comprises:
means for an Internet authorization server receiving control of a browser of said user from a merchant server, and receiving data comprising: merchant id, transaction id, return URL, and a merchant defined as its own entity and which does not contain the user's PIN;
means for said Internet authorization server initiating a call to a host secure module to request a public key, PubK;
means for said host secure module returning PubK+Slot;
means for said Internet authorization server passing JavaScript and PubK back to said browser;
means for said user entering and submitting a PIN, wherein digits are hidden;
means for generating a DES key, KD at said browser;
means for encrypting said entered PIN digits using KD(PIN);
means for encrypting KD using PubK;
means for posting KD(PIN)+PubK(KD) to said IAS;
means for said Internet authorization server passing said KD(PIN)+PubK(KD)+Slot to said host secure module;
means for said host secure module converting said KD(PIN)+PubK(KD)+Slot to MFK(KPE)+KPE(PIN), wherein such conversion is used to create a standard ANSI PIN block;
means for said host secure module passing said MFK(KPE)+KPE(PIN) back to said IAS; and
means for said Internet authorization server storing said MFK(KPE)+KPE(PIN)+Transaction Id+a timestamp in a database.

5. A method for making a purchase transaction by PIN purchasing over the Internet, said method comprising the steps of:
a buyer proceeding to a merchant's checkout page on a merchant server from a buyer's browser to make a purchase;
said buyer selecting PIN Purchase as a payment method and entering an associated debit card number;
said merchant server re-directing said buyer's browser to an Internet authorization server and passing a unique transaction id coupled to said transaction;
said Internet authorization server displaying a secure PIN pad screen and using a unique session key;
said buyer entering said PIN using an input device;
encrypting said PIN using said unique session key;
said Internet authorization server passing said encrypted PIN to a host secure module, wherein said host secure module generates an associated encrypted ANSI PIN block;
said Internet authorization server returning control of said buyer's browser to said merchant server along with said unique transaction id;
said merchant server creating a payment request based on contents of said shopping cart and said payment method, wherein said merchant server sends said payment request to an Internet payments server;
said Internet payments server determining a payment type and formatting a payment authorization request;
said payment authorization request routing to an ATM/POS system, wherein said ATM/POS system takes said encrypted ANSI PIN block and routes it through a second host secure module to be decrypted and translated to an acquiring financial institution's encrypted PIN data;
if said transaction is on-us, then said ATM/POS system validating said PIN and passing an associated transaction amount to a data deposit account system for authorization;
if said transaction is off-us, then said authorization request routing to a network for routing to an issuing financial institution of said buyer;
passing back to said ATM/POS system an authorization approval or denial, wherein said authorization approval or denial is routed to said Internet payments server and finally back to said merchant server.

6. The method of claim 5, wherein said unique session is under Secure Sockets Layer (SSL) technology.

7. The method of claim 5, wherein a link between said Internet authorization server and said Internet payments server is a secure link.

8. The method of claim 5, wherein encrypting a user's PIN further comprises the steps of:
an Internet authorization server receiving control of a browser of said user from a merchant server, and receiving data comprising: merchant id, transaction id, return URL, and a merchant defined as its own entity and which does not contain the user's PIN;
said Internet authorization server initiating a call to a host secure module to request a public key, PubK;
said host secure module returning PubK+Slot;
said Internet authorization server passing JavaScript and PubK back to said browser;
said user entering and submitting a PIN, wherein digits are hidden;
generating a DES key, KD at said browser;
encrypting said entered PIN digits using KD(PIN);
encrypting KD using PubK;
posting KD(PIN)+PubK(KD) to said IAS;
said Internet authorization server passing said KD(PIN)+PubK(KD)+Slot to said host secure module;
said host secure module converting said KD(PIN)+PubK(KD)+Slot to MFK(KPE)+KPE(PIN), wherein such conversion is used to create a standard ANSI PIN block;
said host secure module passing said MFK(KPE)+KPE(PIN) back to said IAS; and
said Internet authorization server storing said MFK(KPE)+KPE(PIN)+Transaction Id+a timestamp in a database.
